(19) United States
(12) Patent Application Publication
(10) Pub. No.: US 2026/0296571 A1
(43) Pub. Date: Oct. 1, 2026

(54) FIRE APPARATUS WITH LOW PROFILE CAB

(71) Applicant: Oshkosh Corporation, Oshkosh, WI (US)

(72) Inventors: Clayton Squires, Oshkosh, WI (US); David Archer, Hortonville, WI (US); Nick Holman, Oshkosh, WI (US)

(73) Assignee: Oshkosh Corporation, Oshkosh, WI (US)

(21) Appl. No.: 19/632,170

(22) Filed: Mar. 27, 2026

Related U.S. Application Data
(60) Provisional application No. 63/781,184, filed on Mar. 31, 2025.

(51) Int. Cl. B62D 33/06; A62C 27/00; B60R 3/00; B62D 21/02; B62D 25/20

(52) U.S. Cl. CPC B62D 33/06; A62C 27/00; B60R 3/002; B62D 21/02; B62D 25/2009

(57) ABSTRACT

A fire apparatus includes a chassis, a front axle coupled to the chassis, a rear axle coupled to the chassis, and a cab coupled to the chassis above the front axle. The front axle includes a plurality of wheel and tire assemblies. The cab includes a cab body defining a cab interior configured to accommodate occupants and a plurality of wheel well assemblies coupled to the cab body. The cab body includes a cab roof defining a top portion of the cab interior. The wheel well assemblies each define a wheel well opening configured to receive one of the plurality of wheel and tire assemblies. The cab roof is positioned a first height above the ground surface that is at most 8.75 feet and a second height above the chassis that is at most 5 feet such that an overall height of the fire apparatus is below a height threshold.

### CROSS-REFERENCE TO RELATED APPLICATION

This application claims the benefit of and priority to U.S. Provisional Application No. 63/781,184, filed Mar. 31, 2025, the entire contents of which is hereby incorporated by reference herein.

### BACKGROUND

A fire apparatus (e.g., a fire truck, etc.) includes a chassis and cab that may be positioned at a forward position on the chassis. However, the height of the cab may cause an overall height of a fire apparatus to be greater than a clearance threshold of a historical fire station designed for smaller fire apparatuses. Such vehicles can therefore have difficulty clearing a garage of historical fire stations due to the height of the cabs from the ground surface.

### SUMMARY

One embodiment relates to a fire apparatus. The fire apparatus includes a chassis, a front axle coupled to the chassis, a rear axle coupled to the chassis rearward of the front axle, and a cab coupled to the chassis above the front axle. The front axle includes a plurality of wheel and tire assemblies configured to support the fire apparatus on a ground surface. The cab includes a cab body defining a cab interior configured to accommodate occupants and a plurality of wheel well assemblies coupled to the cab body. The cab body includes a cab roof defining a top portion of the cab interior. The wheel well assemblies each define a wheel well opening configured to receive one of the plurality of wheel and tire assemblies of the front axle. The cab roof is positioned a first height above the ground that is at most 8.75 feet and a second height above the chassis that is at most 5 feet such that an overall height of the fire apparatus is below a height threshold

Another embodiment relates to a cab for a fire apparatus. The cab includes a cab body defining a cab interior configured to accommodate occupants and a plurality of wheel well assemblies coupled to the cab body. The cab body includes a cab floor defining a bottom portion of the cab interior and a cab roof defining a top portion of the cab interior. The cab floor is configured to be coupled to a chassis of the fire apparatus. The plurality of wheel well assemblies each define a wheel well opening configured to receive one of a plurality of tractive elements of the fire apparatus. When the cab floor is coupled to the chassis, the cab roof is configured to be positioned a first height above the chassis that is at most 5 feet such that an overall height of the fire apparatus is below a height threshold.

Yet another embodiment relates to a fire apparatus. The fire apparatus includes a chassis, a front axle coupled to the chassis, a rear axle coupled to the chassis rearward of the front axle, and a cab coupled to the chassis above the front axle. The front axle includes a plurality of wheel and tire assemblies configured to support the fire apparatus on a ground surface. The cab includes a cab body defining a cab interior configured to accommodate occupants, a cab door configured to move between an open configuration and a closed configuration to selectively facilitate access into the cab interior, a step configured to facilitate accessing the cab interior, and a plurality of wheel well assemblies coupled to the cab body. The cab body includes a cab roof defining a top portion of the cab interior. The step is positioned proximate the cab door. The step defines a step well. The plurality of wheel well assemblies each define a wheel well opening configured to receive one of the plurality of wheel and tire assemblies of the front axle. The cab roof is positioned a first height above the ground surface that is at most 8.75 feet such that an overall height of the fire apparatus is below a height threshold. The step is positioned a second height above the ground surface that is at least 18 inches.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front perspective view of a fire apparatus, according to an exemplary embodiment.

FIG. 2 is a left side view of the fire apparatus of FIG. 1, according to an exemplary embodiment.

FIG. 3 is a right side view of the fire apparatus of FIG. 1, according to an exemplary embodiment.

FIG. 4 is a front perspective view of another fire apparatus, according to an exemplary embodiment.

FIG. 5 is a front perspective view of a portion of the fire apparatus of FIG. 4, according to an exemplary embodiment.

FIG. 6 is a section view of the portion of the fire apparatus of FIG. 1 and/or the fire apparatus of FIG. 4, according to an exemplary embodiment.

FIG. 7 is a front perspective view of a cab of the fire apparatus of FIG. 1 and/or the fire apparatus of FIG. 4, according to an exemplary embodiment.

FIG. 8 is a front section view of the cab of FIG. 7, according to an exemplary embodiment.

FIG. 9 is a rear section view of the cab of FIG. 7, according to an exemplary embodiment.

FIG. 10 is side view of a wheel well of the cab of FIG. 7, according to an exemplary embodiment.

FIG. 11 is a bottom perspective view of the wheel well of FIG. 10, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a vehicle includes various components that improve performance. In one embodiment, the vehicle is a fire apparatus that includes a chassis, a front axle, a rear axle, and a cab. The front axle and the rear axle are coupled to the chassis. The cab is coupled to the chassis above the front axle. The cab includes a cab body defining a cab interior. The cab body includes a cab roof defining a top portion of the cab interior. The cab roof is positioned a first height (e.g., H1) above the ground that is at most 8.75 feet and a second height (e.g., H2) above the chassis that is at most 5 feet such that an overall height of the fire apparatus is below a height threshold.

### Overall Vehicle

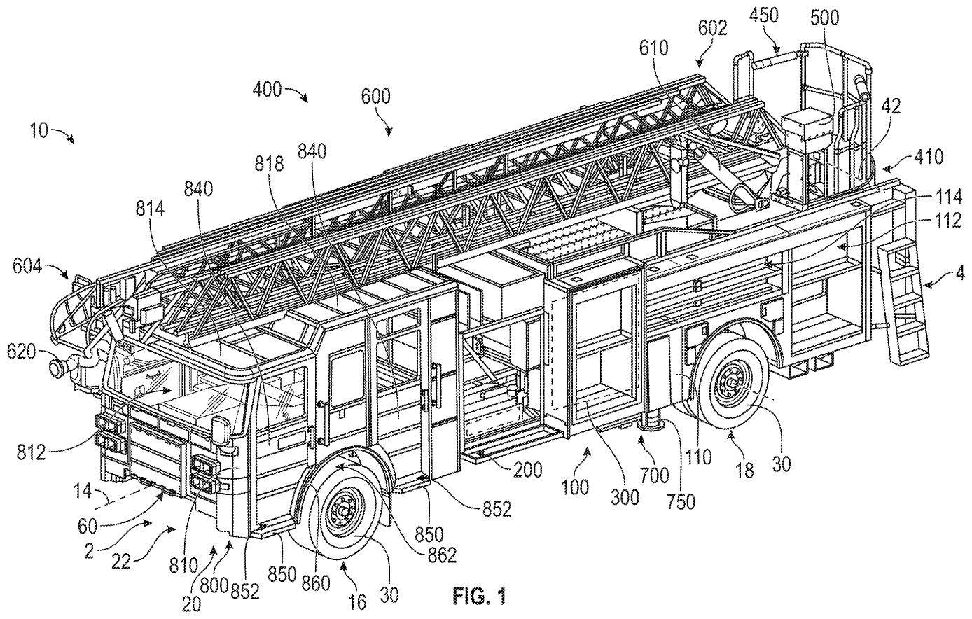

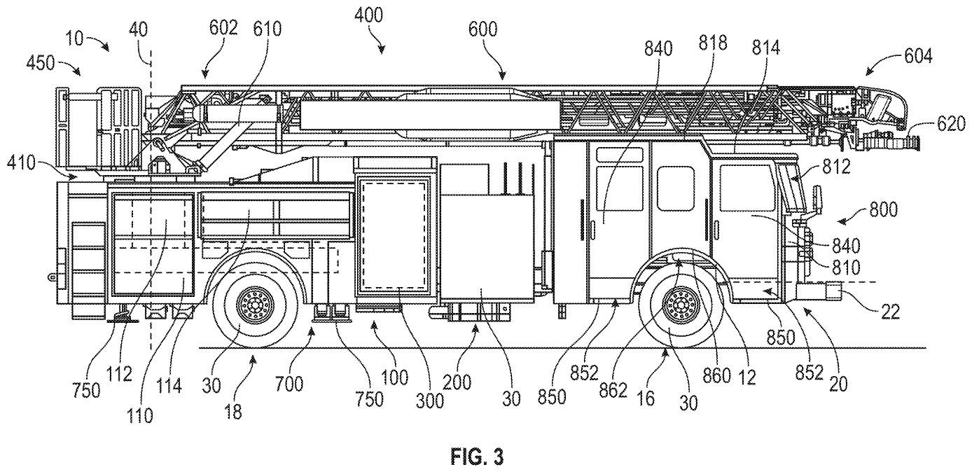

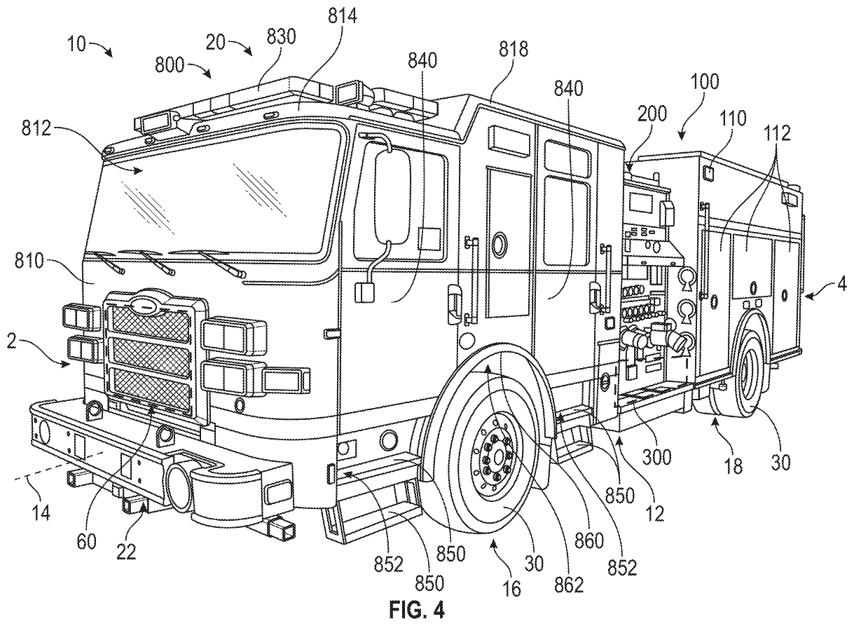

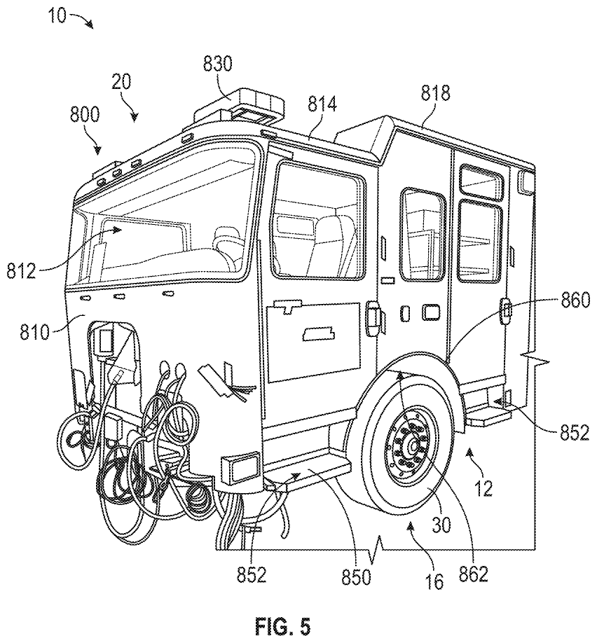

According to the exemplary embodiment shown in FIGS. 1-3, a vehicle, shown as fire apparatus 10, is configured as a rear-mount quint fire truck having a single rear axle. A “quint” fire truck as used herein may refer to a fire truck that includes a water tank, an aerial ladder, hose storage, ground ladder storage, and a water pump. In other embodiments, the fire apparatus 10 is configured as a rear-mount quint fire truck having a tandem rear axle. A single rear axle chassis may include one solid axle configuration or may include one pair of axles each having a set of constant velocity joints and coupling a differential to a pair of hub assemblies, according to various alternative embodiments. A tandem rear axle may include two solid axle configurations or may include two pairs of axles (e.g., two pairs of half shafts, etc.) each having a set of constant velocity joints and coupling two differentials to two pairs of hub assemblies. In still other embodiments, the fire apparatus 10 is configured as a non-quint rear-mount fire truck having a single rear axle or a tandem rear axle. According to the exemplary embodiment shown in FIGS. 4 and 5 the fire apparatus 10 is configured as a non-quint pumper fire truck. The “non-quint” fire truck as used herein may refer to a fire truck that includes a water tank, hose storage, ground ladder storage, and a water pump without including an aerial ladder. In yet other embodiments, the fire apparatus 10 is configured as a mid-mount, quint or non-quint, single rear axle or tandem rear axle, fire truck.

As shown in FIGS. 1-6, the fire apparatus 10 includes a chassis, shown as frame 12, having longitudinal frame rails that define an axis, shown as longitudinal axis 14, that extends between a first end, shown as front end 2, and an opposing second end, shown as rear end 4, of the fire apparatus 10; a single first axle, shown as front axle 16, coupled to the frame 12; a single rear axle, shown as rear axle 18, coupled to the frame 12 rearward of the front axle 16; a first assembly, shown as front cabin 20, coupled to and supported by the frame 12 and having a bumper, shown as front bumper 22; a prime mover, shown as engine 60, coupled to and supported by the frame 12; and a second assembly, shown as rear assembly 100, coupled to and supported by the frame 12. According to an exemplary embodiment, a weight of the fire apparatus 10 is at most 62,000 pounds (e.g., 57,000 pounds, etc.). In other embodiments, the fire apparatus 10 weighs more than 62,000 pounds. In some embodiments, the rear axle 18 is a tandem rear axle.

As shown in FIGS. 1-5, the front axle 16 and the rear axle 18 include tractive assemblies, shown as wheel and tire assemblies 30. The wheel and tire assemblies 30 are configured to support the fire apparatus 10 on a ground surface. As shown in FIGS. 1-5, the front cabin 20 is positioned forward of the rear assembly 100 (e.g., with respect to a forward direction of travel for the fire apparatus 10 along the longitudinal axis 14, etc.). According to an alternative embodiment, the cab assembly may additionally be positioned behind the rear assembly 100 (e.g., with respect to a forward direction of travel for the fire apparatus 10 along the longitudinal axis 14, etc.). The cab assembly may be positioned behind the rear assembly 100 on, by way of example, a rear tiller fire apparatus. In some embodiments, the fire apparatus 10 is a ladder truck with a front portion that includes the front cabin 20 pivotally coupled to a rear portion that includes the rear assembly 100.

According to an exemplary embodiment, the engine 60 receives fuel (e.g., gasoline, diesel, etc.) from a fuel tank and combusts the fuel to generate mechanical energy. A transmission receives the mechanical energy and provides an output to a drive shaft. The rotating drive shaft is received by a differential, which conveys the rotational energy of the drive shaft to a final drive (e.g., the front axle 16, the rear axle 18, the wheel and tire assemblies 30, etc.). The final drive then propels or moves the fire apparatus 10. According to an exemplary embodiment, the engine 60 is a compression-ignition internal combustion engine that utilizes diesel fuel. In alternative embodiments, the engine 60 is another type of prime mover (e.g., a spark-ignition engine, a fuel cell, an electric motor, etc.) that is otherwise powered (e.g., with gasoline, compressed natural gas, propane, hydrogen, electricity, etc.). In some embodiments, the fire apparatus 10 include the engine 60 and a second prime mover (e.g., one or more electric motors) to provide a hybrid or dual-drive drivetrain.

As shown in FIGS. 1-4, the rear assembly 100 includes a body assembly, shown as body 110, coupled to and supported by the frame 12; a fluid driver, shown as pump system 200, coupled to and supported by the frame 12, and a fluid reservoir, shown as water tank 300, coupled to the body 110 and supported by the frame 12. According to the exemplary embodiment shown in FIGS. 1-3, the rear assembly 100 includes an aerial assembly 400, shown as aerial assembly 400 pivotably coupled to the frame 12 (e.g., via a torque box, etc.) and supported by the frame 12. In some embodiments, the rear assembly 100 does not include the pump system 200 and/or the water tank 300 (e.g., a “no pump no tank” configuration). In some embodiments, the rear assembly 100 additionally or alternatively includes an agent or foam tank (e.g., that receives and stores a fire suppressing agent, foam, etc.).

As shown in FIGS. 1-4, the sides of the body 110 define a plurality of compartments, shown as storage compartments 112. The storage compartments 112 may receive and store miscellaneous items and gear used by emergency response personnel (e.g., helmets, axes, oxygen tanks, hoses, medical kits, etc.).

According to the exemplary embodiment shown in FIGS. 1-3, the rear end 4 of the body 110 defines a longitudinal storage compartment that extends along the longitudinal axis 14, shown as ground ladder compartment 114. The ground ladder compartment 114 may receive and store one or more ground ladders. In some embodiments, the ground ladder compartment 114 is configured to store the one or more ground ladders in an upright configuration. By way of example, the ground ladder compartment 114 may be configured to store the one or more ground ladders in the upright configuration where widths across the one or more ground ladders are oriented vertically (e.g., laterally stacked). In other embodiments, the ground ladder compartment 114 is configured to store the one or more ground ladders in a horizontal configuration. By way of example, the ground ladder compartment 114 may be configured to store the one or more ground ladders in the horizontal configuration where widths across the one or more ground ladders are oriented horizontally (e.g., vertically stacked).

In some embodiments, the rear end 4 of the body 110 has notched, angled, or clipped corners (e.g., notched corners, etc.). In other embodiments, the rear end 4 of the body 110 does not have notched, angled, or clipped corners (e.g., the rear end 4 of the body 110 may have square corners, etc.). According to an exemplary embodiment, the notched, angled, or clipped corners provide for increased turning clearance relative to fire apparatuses that have non-notched or non-clipped (e.g., square, etc.) corners.

According to the exemplary embodiment shown in FIGS. 1-3, the aerial assembly 400 includes a turntable assembly, shown as turntable 410, pivotally coupled to the frame 12 (e.g., via a torque box, etc.); a platform, shown work platform 450, coupled to the turntable 410; a console, shown as control console 500, coupled to the turntable 410; a ladder assembly, shown as aerial ladder assembly 600, having a first end (e.g., a base end, a proximal end, a pivot end, etc.), shown as proximal end 602, pivotally coupled to the turntable 410, and an opposing second end (e.g., a free end, a distal end, a platform end, an implement end, etc.), shown as distal end 604. In some embodiments, the aerial assembly 400 includes an implement (e.g., a work basket, water turret, etc.) coupled to the distal end 604. The turntable 410 is pivotably coupled to the frame 12 such that the aerial assembly is selectively repositionable into a plurality of operating orientation about a vertical axis, shown as vertical pivot axis 40.

According to an exemplary embodiment, the work platform 450 provides a surface upon which operators (e.g., fire fighters, rescue workers, etc.) may stand while operating the aerial assembly 400 (e.g., with the control console 500, etc.). The control console 500 may be communicably coupled to various components of the fire apparatus 10 (e.g., actuators of the aerial ladder assembly 600, a water turret, etc.) such that information or signals (e.g., command signals, fluid controls, etc.) may be exchanged from the control console 500. The information or signals may relate to one or more components of the fire apparatus 10. According to an exemplary embodiment, the control console 500 enables an operator (e.g., a fire fighter, etc.) of the fire apparatus 10 to communicate with one or more components of the fire apparatus 10. By way of example, the control console 500 may include at least one of an interactive display, a touchscreen device, one or more buttons (e.g., a stop button configured to cease water flow through a water nozzle, etc.), joysticks, switches, and voice command receivers. An operator may use a joystick associated with the control console 500 to trigger the actuation of the turntable 410 and/or the aerial ladder assembly 600 to a desired angular position (e.g., to the front, back, or side of fire apparatus 10, etc.). By way of another example, an operator may engage a lever associated with the control console 500 to trigger the extension or retraction of the aerial ladder assembly 600.

The aerial ladder assembly 600 includes first ladder actuators (e.g., hydraulic cylinders, etc.), shown as pivot actuators 610. According to an exemplary embodiment, the pivot actuators 610 are configured to pivot the distal end 604 of the aerial ladder assembly 600 about a lateral axis, shown as lateral pivot axis 42. According to an exemplary embodiment, the aerial ladder assembly 600 has a plurality of nesting ladder sections that telescope with respect to one another. The aerial ladder assembly 600 may include one or more second ladder actuators that are positioned to facilitate selectively reconfiguring the aerial ladder assembly 600 between an extended configuration and a retracted/stowed configuration. In the extended configuration (e.g., deployed position, use position, etc.), the aerial ladder assembly 600 is lengthened, and the distal end 604 is extended away from the proximal end 602. In the retracted configuration (e.g., storage position, transport position, etc.), the aerial ladder assembly 600 is shortened, and the distal end 604 is withdrawn towards the proximal end 602.

According to the exemplary embodiment shown in FIGS. 1-3, an implement, shown as nozzle 620 (e.g., deluge gun, water cannon, deck gun, etc.), is disposed at the distal end 604 of the aerial ladder assembly 600. The nozzle 620 is connected to a water source (e.g., the water tank 300, an external source, etc.) via an intermediate conduit extending along the aerial ladder assembly 600 (e.g., along the side of the aerial ladder assembly 600, beneath the aerial ladder assembly 600, in a channel provided in the aerial ladder assembly 600, etc.). By pivoting the aerial ladder assembly 600 into the raised position, the nozzle 620 may be elevated to expel water from a higher elevation to facilitate suppressing a fire. In some embodiments, the distal end 604 of the aerial ladder assembly 600 includes a basket. The basket may be configured to hold at least one of fire fighters and persons being aided by the fire fighters. The basket provides a platform from which a fire fighter may complete various tasks (e.g., operate the nozzle 620, create ventilation, overhaul a burned area, perform a rescue operation, etc.).

According to the exemplary embodiment shown in FIGS. 1-3, the fire apparatus 10 includes a stability system, shown as stability assembly 700, including stabilizers, shown as outriggers 750, coupled to each lateral side of the frame 12 proximate the front cabin 20 and/or the rear assembly 100. According to an exemplary embodiment, the outriggers 750 are selectively deployable (e.g., extendable laterally outward and downward to engage a ground surface). In some embodiments, the outriggers 750 are positioned under the frame 12. By way of example, the outriggers 750 may be slung under the frame 12 (e.g., underslung, etc.). In some embodiments, the stability assembly 700 includes front downriggers coupled to each lateral side of the front bumper 22 and/or the frame 12 at the front end 2 of the frame 12. The front downriggers may be selectively deployable (e.g., extendable, etc.) downward to engage a ground surface. In some embodiments, the stability assembly 700 includes rear downriggers and/or rear outriggers coupled to each lateral side of the frame 12 at or proximate the rear end 4 of the frame 12. The rear downriggers and/or rear outriggers may be selectively deployable (e.g., extendable, etc.) laterally outward and/or downward to engage a ground surface.

### Low Profile Cab

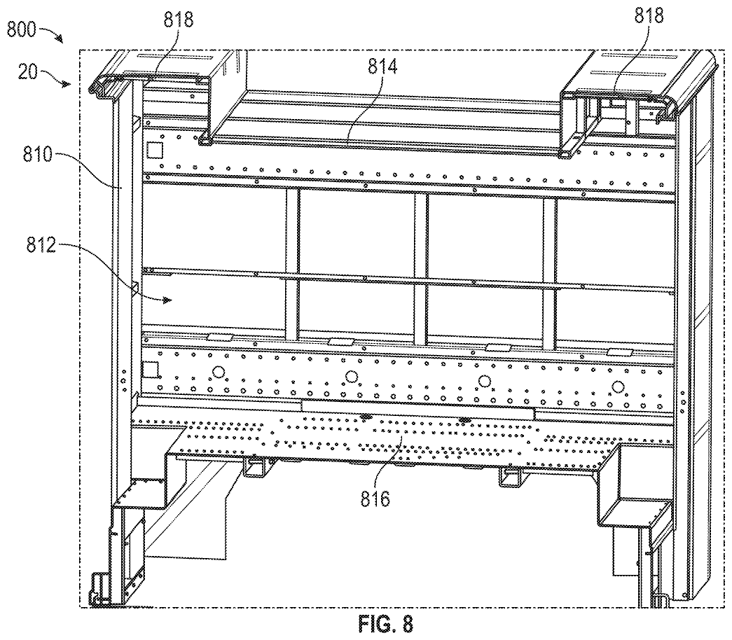

According to the exemplary embodiment shown in FIGS. 1-9, the front cabin 20 is a low profile cabin, shown as low profile front cabin 800. The low profile front cabin 800 is coupled to and/or supported by the frame 12. The low profile front cabin 800 may be coupled to and/or supported by the frame 12 in a position that is lower than where a front cabin of a traditional fire apparatus is supported by a frame of the traditional fire apparatus. By way of example, the low profile front cabin 800 may be coupled to the frame 12 in a position that is at least 3 inches (e.g., 3.5 inches, etc.) lower than where a front cabin of a traditional fire apparatus is supported by a frame of the traditional fire apparatus. The low profile front cabin 800 is configured to facilitate a height of the fire apparatus 10 being below a height threshold associated with the fire apparatus 10. By way of example, the low profile front cabin 800 may facilitate the height of the fire apparatus 10 being below the height threshold associated with a legacy fire station such that the fire apparatus 10 may be parked inside of the legacy fire station.

As shown in FIGS. 1-9, the low profile front cabin 800 includes a main body, shown as cabin body 810, a plurality of doors, shown as cabin doors 840, coupled to the cabin body 810 and configured to selectively facilitate access into the low profile front cabin 800, a plurality of cabin steps, shown as steps 850, coupled to the cabin body 810, and a plurality of wheel well assemblies 860, coupled the cabin body 810 and configured to receive the wheel and tire assemblies 30 of the front axle 16.

As shown in FIGS. 1-10, the cabin body 810 defines an interior volume, shown as cab interior 812, that is sized to accommodate one or more operators (e.g., firemen). The cabin doors 840 facilitate selective access to the cab interior 812 from outside of the fire apparatus 10. The cab interior 812 includes one or more components that facilitate operation of the fire apparatus 10 by an operator. By way of example, the cab interior 812 may include at least one seat configured to support operators, at least one user interface component (e.g., a steering wheel, an acceleration pedal, a brake pedal, etc.) configured to facilitate operator control over drive components (e.g., the wheel and tire assemblies 30, etc.) of the fire apparatus 10 and/or over any implements of the fire apparatus 10 (e.g., the aerial assembly 400, the pump system 200, the water tank 300, etc.), and user interface components that provide information to the operators (e.g., lights, gauges, speakers, etc.).

As shown in FIGS. 1-9, the cabin body 810 includes a roof, shown as cabin roof 814, defining a top portion of the cab interior 812. By way of example, the cabin roof 814 may extend along an upper portion of the cab interior 812. According to an exemplary embodiment, when the aerial ladder assembly 600 is in the retracted configuration and is oriented in a direction along the longitudinal axis 14, the aerial ladder assembly 600 is positioned above the cabin roof 814. In some embodiments, the cabin roof 814 is positioned above an operator portion (e.g., a forward portion, etc.) of the cab interior 812. By way of example, the cabin roof 814 may be positioned above a head of an operator of the fire apparatus 10 when the operator is positioned within the cab interior 812.

According to the exemplary embodiment shown in FIGS. 4 and 5, the low profile front cabin 800 includes a light assembly, shown as lightbar assembly 830, coupled to a top surface of the cabin roof 814. The lightbar assembly 830 is configured to emit lights in various patterns, with various colors, at various frequencies, and/or with varying intensities or brightness. For example, the lightbar assembly 830 may emit pulsing lights, strobing lights, constant lights (e.g., spotlight), colored lights, etc. The lightbar assembly 830 may provide flashing lights or controlled to flash such that, when flashing, that the lightbar assembly 830 indicates that the fire apparatus 10 is deployed for emergency purposes (e.g., to respond to a fire, a motor vehicle accident, etc.). In some embodiments, one or more components of the lightbar assembly 830 emit a constant, bright light to illuminate a scene so operators, emergency personnel, workers, etc. may be able to see an otherwise dark scene or the fire apparatus 10, for example.

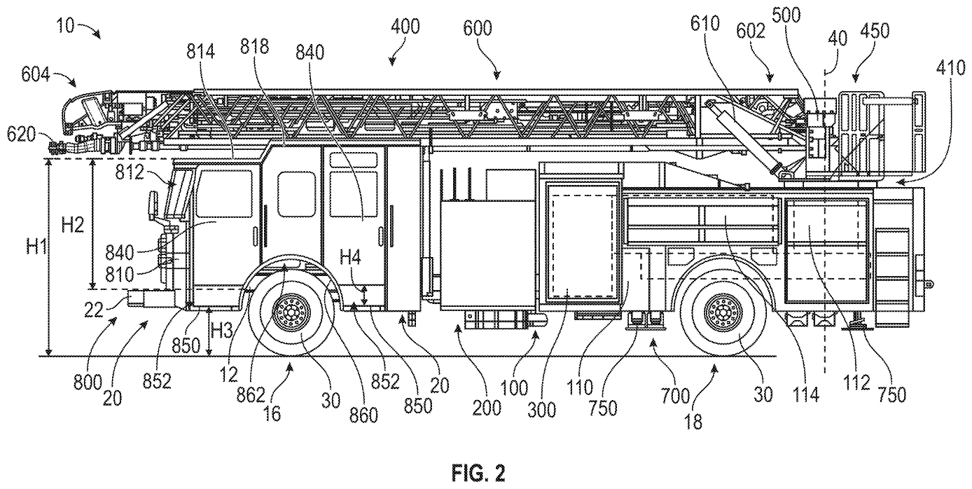

As shown in FIG. 2, the cabin roof 814 has a height H1 above the ground surface supporting the fire apparatus 10 (e.g., a height from the ground surface to a top surface of the cabin roof 814, etc.). According to an exemplary embodiment, the height H1 of the cabin roof 814 above the ground surface is at most about 105 inches (i.e., 8 feet, 8 inches, 8.75 feet, less than 100 inches, between 95 inches and 105 inches, greater than 95 inches). By way of example, the height H1 may be about 100 inches (i.e., about 99.3125 inches). The height H1 may be shorter than a height of a cabin roof of a traditional fire apparatus with comparable capabilities (e.g., a comparable extension capability, a comparable storage capability, a comparable towing capability, etc.) as the fire apparatus 10. By way of example, the height H1 of the cabin roof 814 above the ground surface may be at least three inches lower than a height of a cabin roof of a traditional fire apparatus.

As shown in FIG. 2, the cabin roof 814 has a height H2 above the frame 12 (e.g., a height from a top surface of the frame 12 to a top surface of the cabin roof 814, a height from where the cabin body 810 is coupled to the frame 12 to the cabin roof 814, etc.). According to an exemplary embodiment, the height H2 of the cabin roof 814 above the frame 12 is at most about 60 inches (i.e., 5 feet). By way of example, the height H2 may be about 57 inches. The height H2 may be shorter than a height of a cabin roof of a traditional fire apparatus above a frame of the traditional fire apparatus with comparable capabilities as the fire apparatus 10. By way of example, the height H2 of the cabin roof 814 above the frame 12 may be at least three inches lower than a height of a cabin roof of a traditional fire apparatus above a frame of the traditional fire apparatus. Decreasing the height H1 of the cabin roof 814 above the ground surface supporting the fire apparatus 10 and/or the height H2 of the cabin roof 814 above the frame 12 improves clearance of the fire apparatus 10 and substantially increases a number of historical fire stations (e.g., historical fire stations that were built to house historical fire apparatuses, etc.) that may receive the fire apparatus 10 without modifying a clearance height of the legacy fire stations. By way of example, decreasing the height H1 of the cabin roof 814 above the ground surface supporting the fire apparatus 10 may bring a height of the fire apparatus 10 below a height threshold of historical fire stations to facilitate storing the fire apparatus 10 within the historical fire stations.

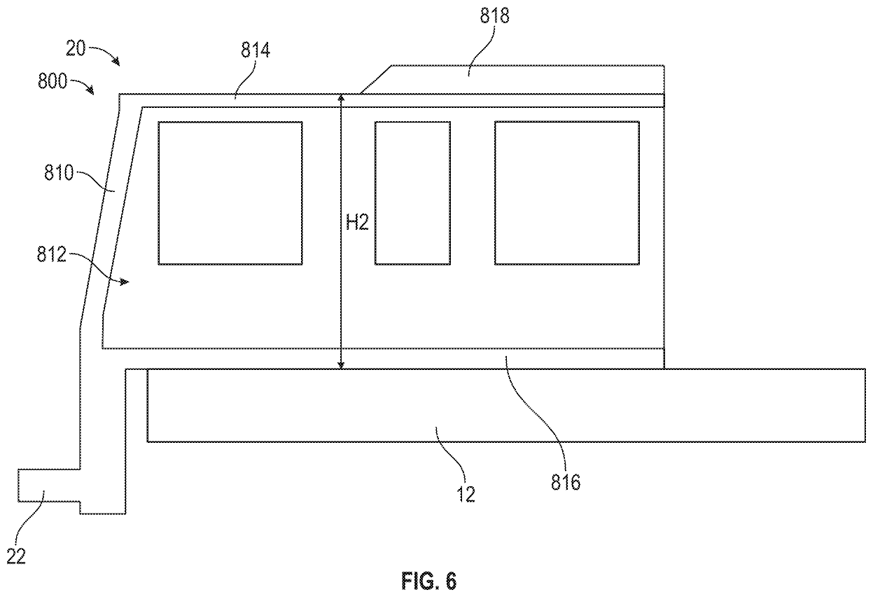

As shown in FIGS. 6-10, the cabin body 810 includes a floor, shown as cabin floor 816, defining a bottom portion of the cab interior 812. By way of example, the cabin floor 816 may extend along a lower portion of the cab interior 812. The cabin floor 816 is configured to support the occupants within the cab interior 812. By way of example, the cabin floor 816 may support the feet of the operator of the fire apparatus 10 when the operator is positioned within the cab interior 812. In some embodiments, a portion of the cabin floor 816 is positioned above the frame 12. For example, a center portion of the cabin floor 816 proximate the longitudinal axis 14 may be positioned above the frame 12. In some embodiments, the cabin floor 816 is coupled to the frame 12. By way of example, the cabin floor 816 may couple the low profile front cabin 800 to the frame 12.

According to an exemplary embodiment shown in FIGS. 1-8, the cabin body 810 includes a plurality of rooftop extensions, shown as cabin roof extension portions 818. The cabin roof extension portions 818 extend above the cabin roof 814. The cabin roof extension portions 818 increase a height of portions of the cab interior 812. By way of example, the cab interior 812 may have a first height from the cabin floor 816 to the cabin roof 814 and a second height from the cabin floor 816 to the cabin roof extension portions 818 that is greater than the first height. The cabin roof extension portions 818 may allow for an occupant of the cab interior 812 to stand up within the cab interior 812. By way of example, a first height between the cabin floor 816 and the cabin roof 814 may be less than a standing height of an occupant of the cab interior 812, but a second height between the cabin floor 816 and the cabin roof extension portions 818 may be greater than the standing height of the occupant of the cab interior 812 such that the occupant may stand within the cab interior 812 when positioned below the cabin roof extension portions 818. In other embodiments, the cabin body 810 does not include the cabin roof extension portions 818 such that the cabin roof 814 defines a top surface of the cabin body 810.

In some embodiments, each of the cabin roof extension portions 818 may be positioned proximate one of the cabin doors 840 such that the occupants of the cab interior 812 may stand when entering and/or exiting the cab interior 812. By way of example, a first of the cabin roof extension portions 818 may be positioned on a first side of the fire apparatus 10 proximate a first of the cabin doors 840 such that occupants may stand when entering and/or exiting the cab interior 812 through the first of the cabin doors 840 and a second of the cabin roof extension portions 818 may be positioned on an opposing second side of the fire apparatus 10 proximate a second of the cabin doors 840 such that occupants may stand when entering and/or exiting the cab interior 812 through the second of the cabin doors 840. In some embodiments, the cabin roof extension portions 818 are positioned proximate the cabin doors 840 positioned closer to the rear of the cab interior 812. By way of another example, each of the cabin roof extension portions 818 may be positioned proximate one of the sides of the cab 800. In some embodiments, a portion of the cabin roof 814 is positioned between the cabin roof extension portions 818. By way of example, the cab interior 812 may have a first height from the cabin floor 816 to a first of the cabin roof extension portions 818 on a first side of the fire apparatus 10, the first height from the cabin floor 816 to a second of the cabin roof extension portions 818 on an opposing second side of the fire apparatus 10, and second height from the cabin floor 816 to a portion of the cabin roof 814 positioned between the first of the cabin roof extension portions 818 and the second of the cabin roof extension portions 818, the second height shorter than the first height. Accordingly, a recess may be defined between the cabin roof extension portions 818, and the distal end 604 of the aerial ladder assembly 600 may be stowed within the recess.

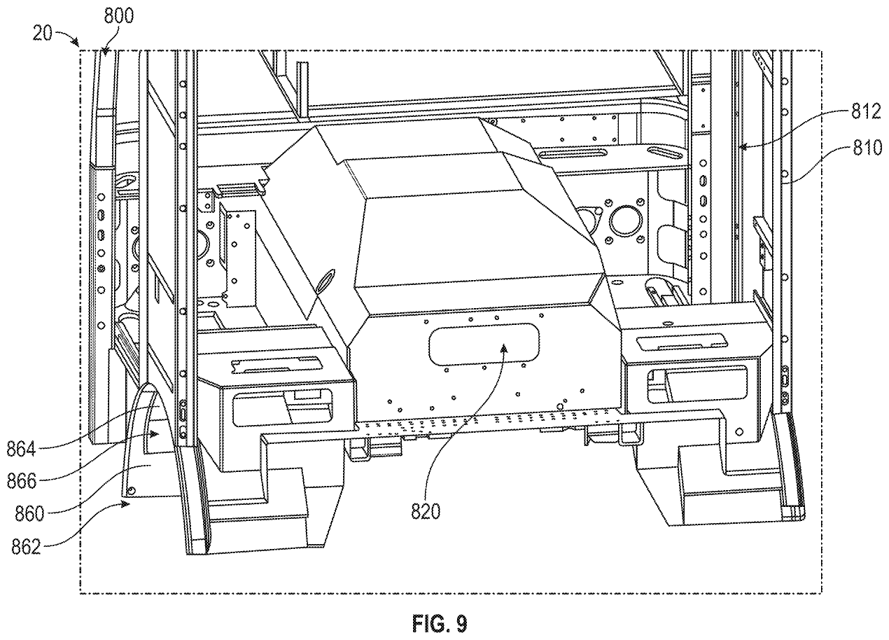

As shown in FIG. 9, the cabin body 810 defines a prime mover opening, shown as engine opening 820, configured to receive at least a portion of the engine 60 and/or a transmission of the fire apparatus 10. The cabin floor 816 may define the engine opening 820. By way of example, a first portion of the cabin floor 816 on a first side of the fire apparatus 10 may be positioned under a driver seat of the low profile front cabin 800, a second portion of the cabin floor 816 on a second side of the fire apparatus 10 may be positioned under a passenger seat of the low profile front cabin 800, and an intermediate portion of the cabin floor 816 positioned between the first portion of the cabin floor 816 and the second portion of the cabin floor 816 may define the engine opening 820 such that a portion of the engine 60 and/or a transmission of the fire apparatus 10 is positioned between the driver seat and the passenger seat of the low profile front cabin 800 (e.g., the portion of the engine 60 is positioned above and between the first portion of the cabin floor 816 and the second portion of the cabin floor 816, etc.).

The cabin doors 840 are configured to move between open configurations where the cabin doors 840 allow access into the cab interior 812 and closed configurations where the cabin doors 840 inhibit access into the cab interior 812. In some embodiments, the cabin doors 840 are pivotably coupled to the cabin body 810 such that the cabin doors 840 move between the open configurations and the closed configurations by rotating about vertical axes. The cabin doors 840 may be pivotably coupled to the cabin body 810 along front edges of the cabin doors 840 or back edges of the cabin doors 840. In some embodiments, the cabin doors 840 swing outward from the cab interior 812 when moving from the closed configuration towards the open configuration. In other embodiments, the cabin doors 840 swing inward towards the cab interior 812 when moving from the closed configuration towards the open configuration. In still other embodiments, the cabin doors 840 slide relative to the cabin body 810 between the open configuration and the closed configuration.

According to the exemplary embodiment shown in FIGS. 1-5, rear doors of the cabin doors 840 may be positioned proximate the cabin roof extension portions 818 such that the rear doors of the cabin doors 840 extend above the cabin roof 814. By extending above the cabin roof 814, the rearward of the cabin body 810 may allow for occupants of the cab interior 812 to enter and/or exit the cab interior 812 while standing substantially vertical.

The steps 850 are configured to facilitate operators accessing the low profile front cabin 800. The steps 850 are each positioned proximate one of the cabin doors 840 to facilitate occupants entering and/or exiting the cab interior 812 through the cabin doors 840. In some embodiments, one of the steps 850 is positioned proximate each of the cabin doors 840. In other embodiments, more than one of the steps 850 are positioned proximate each of the cabin doors 840. By way of example, a lower step of the steps 850 and an upper step of the steps 850 may be positioned proximate one or more of the cabin doors 840.

As shown in FIGS. 1-5, each of the cabin doors 840 and a corresponding one of the steps 850 cooperatively define step openings, shown as step wells 852. The step wells 852 may receive feet of the occupants of the cab interior 812 when the occupants are utilizing the steps 850 to enter and/or exit the cab interior 812. When more than one of the steps 850 is positioned proximate a respective one of the cabin doors 840, the upper step of the steps 850 positioned closer to the cabin doors 840 and the cabin doors 840 collectively define the step wells 852.

As shown in FIG. 2, the steps 850 have a height H3 above the ground surface supporting the fire apparatus 10 (e.g., a height from the ground surface to a top surface of the steps 850, a height from the ground surface to an upper step of the steps 850, a height from the ground surface to a bottom of the step wells 852, etc.). According to an exemplary embodiment, the height H3 of the steps 850 above the ground surface is at least about 18 inches (i.e., 1 foot, 6 inches, greater than 20 inches, between 18 inches and 22 inches, less than 22 inches). By way of example, the height H3 may be about 20 inches (i.e., about 20.125 inches). The height H3 may be substantially similar to a height of a step of a traditional fire apparatus with comparable capabilities (e.g., a comparable extension capability, a comparable storage capability, a comparable towing capability, etc.) as the fire apparatus 10. By way of example, the height H3 of the steps 850 above the ground surface may be within one inch of a height of a step of a traditional fire apparatus, even though the low profile front cabin 800 has an overall lower height (e.g., H1, H2, etc.) relative to the traditional fire apparatus.

As shown in FIG. 2, when the cabin doors 840 are in the closed configuration, the step wells 852 have a height H4 (e.g., a height from a top surface of the lower step of the steps 850 to a bottom surface of the cabin doors 840, a height from the lower step of the steps 850 to the cabin doors 840, etc.). According to an exemplary embodiment, the height H4 of the step wells 852 when the cabin doors 840 are in the closed configuration is at most about 10 inches (e.g., less than 9 inches, greater than 8 inches, between 8 inches and 10 inches). By way of example, the height H4 may be about 9 inches (i.e., about 8.75 inches). The height H4 may be shorter than a height of a step well of a traditional fire apparatus with a cabin door in a closed configuration with comparable capabilities as the fire apparatus 10. Decreasing the height H4 of the step wells 852 when the cabin doors 840 are in the closed configuration without substantially decreasing the height H3 of the steps 850 above the ground surface allows for the low profile front cabin 800 to be positioned lower on the frame 12 without changing a step height of the steps 850 above the ground surface.

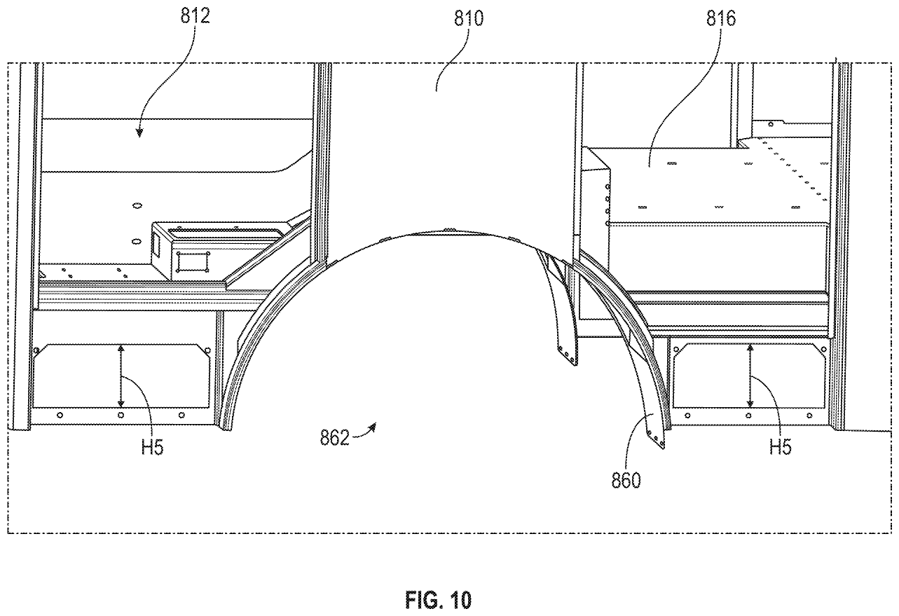

As shown in FIG. 10, when the cabin doors 840 are in the open configuration, the step wells 852 have a height H5 (e.g., a height from a top surface of the lower step of the steps 850 to a bottom surface of the low profile front cabin 800 positioned above the top surface of the lower step of the steps 850, a height from a top surface of the lower step of the steps 850 to a bottom surface of an upper step of the steps 850, etc.). According to an exemplary embodiment, the height H5 of the step wells 852 when the cabin doors 840 are in the open configuration is at most about 11 inches (e.g., less than 10 inches, greater than 9 inches, between 9 inches and 11 inches, greater than H4). By way of example, the height H5 may be about 9.5 inches (i.e., about 9.625 inches). The height H5 may be shorter than a height of a step well of a traditional fire apparatus with a cabin door in an open configuration with comparable capabilities as the fire apparatus 10. Decreasing the height H5 of the step wells 852 when the cabin doors 840 are in the open configuration without substantially decreasing the height H3 of the steps 850 above the ground surface allows for the low profile front cabin 800 to be positioned lower on the frame 12 without changing a step height of the steps 850 above the ground surface.

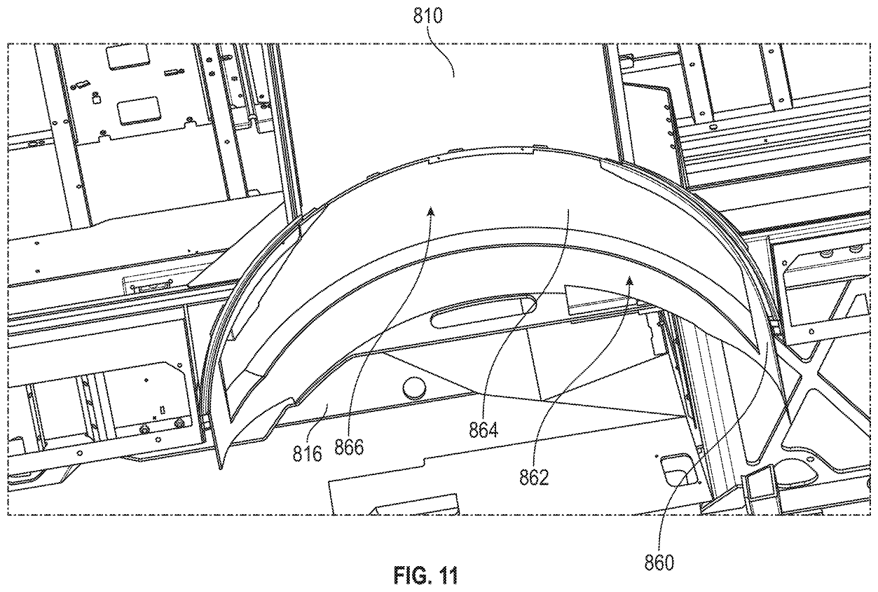

As shown in FIGS. 1-5, 7, and 9-11, each of the wheel well assemblies 860 defines a wheel opening, shown as wheel well 862, configured to receive a portion of one of the wheel and tire assemblies 30 of the front axle 16. By way of example, the wheel well 862 may be a cylindrical shaped opening to receive a rounded portion of one of the wheel and tire assemblies 30 of the front axle 16. The wheel wells 862 facilitate the low profile front cabin 800 being positioned closer to the wheel and tire assemblies 30 of the front axle 16 and/or the ground surface when portions of the wheel and tire assemblies 30 of the front axle 16 are received within the wheel wells 862 compared to when the low profile front cabin 800 is positioned entirely above the wheel and tire assemblies 30 of the front axle 16. By way of example, when top portions of the wheel and tire assemblies 30 of the front axle 16 are received by the wheel wells 862, the low profile front cabin 800 may be positioned closer to the ground surface compared to when the top portions of the wheel and tire assemblies 30 of the front axle 16 are positioned below the low profile front cabin 800.

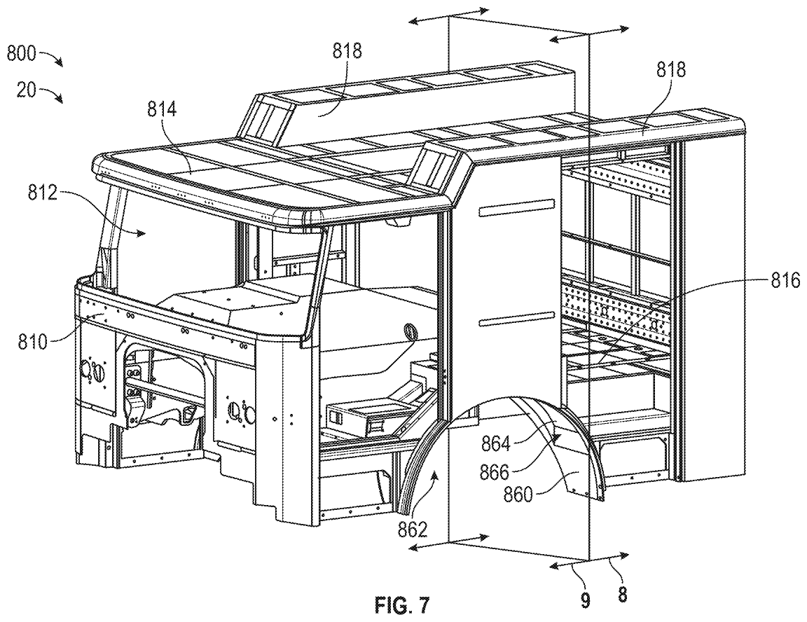

According to the exemplary embodiment shown in FIGS. 7, 9, and 11, each of the wheel well assemblies 860 includes a notched portion, shown as wheel well notch portion 864, defining a notch opening, shown as wheel well notch 866. By way of example, wheel well surfaces of the wheel well assemblies 860 may define the wheel wells 862 and channels of the wheel well assembly 860 extending above the wheel well surfaces may define the wheel well notches 866. The wheel well notch 866 extends above the wheel well 862 into the low profile front cabin 800 (e.g., towards the cabin roof 814, into the cab interior 812, etc.). The wheel well notches 866 may facilitate the low profile front cabin 800 being positioned closer to the wheel and tire assemblies 30 and/or the ground surface when uppermost portions of the wheel and tire assemblies 30 of the front axle 16 are received within the wheel well notches 866 as compared to if the wheel well assemblies 860 did not include the wheel well notch portions 864.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrase “at least one of X, Y, and Z” and “at least one of X, Y, or Z,” unless specifically stated otherwise, is understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire apparatus 10 and the systems and components thereof as shown in the various exemplary embodiments is illustrative only. Additionally, any element disclosed in one embodiment may be incorporated or utilized with any other embodiment disclosed herein.

1. A fire apparatus comprising:
a chassis;
a front axle coupled to the chassis, the front axle including a plurality of wheel and tire assemblies configured to support the fire apparatus on a ground surface;
a rear axle coupled to the chassis rearward of the front axle; and
a cab coupled to the chassis above the front axle, the cab including:
a cab body defining a cab interior configured to accommodate occupants, the cab body including a cab roof defining a top portion of the cab interior; and
a plurality of wheel well assemblies coupled to the cab body, the plurality of wheel well assemblies each defining a wheel well opening configured to receive one of the plurality of wheel and tire assemblies of the front axle;
wherein the cab roof is positioned a first height above the ground surface that is at most 8.75 feet and a second height above the chassis that is at most 5 feet such that an overall height of the fire apparatus is below a height threshold.

2. The fire apparatus of claim 1, wherein the cab body includes:
a cab floor defining a bottom portion of the cab interior; and
a plurality of roof extension portions extending above the cab roof such that the cab interior has a third height from the cab floor to the cab roof and a fourth height from the cab floor to the plurality of roof extension portions, the fourth height greater than the third height.

3. The fire apparatus of claim 2, wherein:
the cab includes a plurality of cab doors configured to move between open configurations and closed configurations to selectively facilitate access into the cab interior; and
each of the plurality of roof extension portions is positioned proximate one of the plurality of cab doors.

4. The fire apparatus of claim 1, wherein:
the cab includes:
a cab door configured to move between an open configuration and closed configuration to selectively facilitate access into the cab interior; and
a step configured to facilitate accessing the cab interior, the step positioned proximate the cab door, the step defining a step well; and
when the cab door is in the closed configuration, the step well has a third height from the step to a bottom of the cab door that is at most 10 inches.

5. The fire apparatus of claim 4, wherein, when the cab door is in the open configuration, the step well has a fourth height greater than the third height.

6. The fire apparatus of claim 4, wherein the step is positioned a fourth height above the ground surface that is at least 18 inches.

7. The fire apparatus of claim 1, wherein each of the plurality of wheel well assemblies includes a notch portion extending above the wheel well opening configured to receive a top portion of the one of the plurality of wheel and tire assemblies of the front axle received by the wheel well opening.

8. The fire apparatus of claim 7, wherein the notch portions extend into the cab interior.

9. The fire apparatus of claim 1, wherein:
the chassis includes a plurality of longitudinal frame rails; and
the second height is from top surfaces of the plurality of longitudinal frame rails to the cab roof.

10. A cab for a fire apparatus, the cab comprising:
a cab body defining a cab interior configured to accommodate occupants, the cab body including:
a cab floor defining a bottom portion of the cab interior, the cab floor configured to be coupled to a chassis of the fire apparatus; and
a cab roof defining a top portion of the cab interior; and
a plurality of wheel well assemblies coupled to the cab body, the plurality of wheel well assemblies each defining a wheel well opening configured to receive one of a plurality of tractive elements of the fire apparatus;
wherein, when the cab floor is coupled to the chassis, the cab roof is configured to be positioned a first height above the chassis that is at most 5 feet such that an overall height of the fire apparatus is below a height threshold.

11. The cab of claim 10, wherein the cab body includes a plurality of roof extension portions extending above the cab roof such that the cab interior has a second height from the cab floor to the cab roof and a third height from the cab floor to the plurality of roof extension portions, the third height greater than the second height.

12. The cab of claim 11, further comprising a plurality of cab doors configured to move between open configurations and closed configurations to selectively facilitate access into the cab interior;
wherein each of the plurality of roof extension portions is positioned proximate one of the plurality of cab doors.

13. The cab of claim 10, further comprising:
a cab door configured to move between an open configuration and a closed configuration to selectively facilitate access into the cab interior; and
a step configured to facilitate accessing the cab interior, the step positioned proximate the cab door, the step defining a step well;
wherein, when the cab door is in the closed configuration, the step well has a second height from the step to a bottom of the cab door that is at most 10 inches.

14. The cab of claim 13, wherein, when the cab door is in the open configuration, the step well has a third height greater than the second height.

15. The cab of claim 10, wherein each of the plurality of wheel well assemblies includes a notch portion extending above the wheel well opening configured to receive a top portion of the one of the plurality of tractive elements of the fire apparatus received by the wheel well opening.

16. The cab of claim 15, wherein the notch portions extend into the cab interior.

17. The cab of claim 10, wherein:
the cab floor is configured to couple to top surfaces of a plurality of longitudinal frame rails of the chassis; and
the first height is from top surfaces of the plurality of longitudinal frame rails to the cab roof.

18. A fire apparatus comprising:
a chassis;
a front axle coupled to the chassis, the front axle including a plurality of wheel and tire assemblies configured to support the fire apparatus on a ground surface;
a rear axle coupled to the chassis rearward of the front axle; and
a cab coupled to the chassis above the front axle, the cab including:
a cab body defining a cab interior configured to accommodate occupants, the cab body including a cab roof defining a top portion of the cab interior;
a cab door configured to move between an open configuration and a closed configuration to selectively facilitate access into the cab interior;
a step configured to facilitate accessing the cab interior, the step positioned proximate the cab door, the step defining a step well; and
a plurality of wheel well assemblies coupled to the cab body, the plurality of wheel well assemblies each defining a wheel well opening configured to receive one of the plurality of wheel and tire assemblies of the front axle;
wherein the cab roof is positioned a first height above the ground surface that is at most 8.75 feet such that an overall height of the fire apparatus is below a height threshold; and
wherein the step is positioned a second height above the ground surface that is at least 18 inches.

19. The fire apparatus of claim 18, wherein when the cab door is in the closed configuration, the step well has a third height from the step to a bottom of the cab door that is at most 10 inches.

20. The fire apparatus of claim 19, wherein, when the cab door is in the open configuration, the step well has a fourth height greater than the third height.
